(19) United States
(12) Patent Application Publication
(10) Pub. No.: US 2025/0370939 A1
(43) Pub. Date: Dec. 4, 2025

(54) WEIGHTED DISTRIBUTED-ACCESS ACROSS MEMORY SPACES

(71) Applicant: Micron Technology, Inc., Boise, ID (US)

(72) Inventors: Luca Porzio, Casalnuovo (IT); Vincenzo Reina, Munich (DE)

(21) Appl. No.: 19/215,432

(22) Filed: Jun. 5, 2025

Related U.S. Application Data
(60) Provisional application No. 63/656,003, filed on Jun. 4, 2024.

(51) Int. Cl. G06F 13/18; G06F 13/16

(52) U.S. Cl. CPC G06F 13/18; G06F 13/1626; G06F 13/1647

(57) ABSTRACT

Methods, systems, and devices for weighted distributed-access across memory spaces are described. Multiple commands may be received. The multiple commands may include first commands associated with a first memory space of a memory system that is assigned a first priority of multiple priorities, second commands associated with a second memory space of the memory system that is assigned a second priority of the multiple priorities, and third commands associated with a third memory space of the memory system that is assigned a third priority of the multiple priorities. The multiple commands may be executed using an interleaving pattern that is based on the priorities of the memory spaces.

### CROSS REFERENCE

The present application for patent claims priority to U.S. Patent Application No. 63/656,003 by Porzio et al., entitled “WEIGHTED DISTRIBUTED-ACCESS ACROSS MEMORY SPACES,” filed Jun. 4, 2024, which is assigned to the assignee hereof, and which is expressly incorporated by reference in its entirety herein.

### TECHNICAL FIELD

The following relates to one or more systems for memory, including weighted distributed-access across memory spaces.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports weighted distributed-access across memory spaces in accordance with examples as disclosed herein.

FIG. 2 shows an example of a set of operations for weighted distributed-access across memory spaces in accordance with examples as disclosed herein.

FIG. 3 shows example queue operations for weighted distributed-access across memory spaces in accordance with examples as disclosed herein.

FIG. 4 shows a block diagram of a memory system that supports weighted distributed-access across memory spaces in accordance with examples as disclosed herein.

FIG. 5 shows a flowchart illustrating a method or methods that support weighted distributed-access across memory spaces in accordance with examples as disclosed herein.

### DETAILED DESCRIPTION

One or more host systems (e.g., a navigation system, an autonomous driving system, an entertainment system, a diagnostic system, a wireless communication system, etc.) may have access to a memory system. Similarly, one or more applications installed at the one or more host system may have access to the memory system. Thus, a memory system may be shared by multiple host systems and/or multiple applications. Data may be stored for one or more host systems/applications in multiple memory spaces (e.g., logical units) of the memory system. In such cases, the host systems/applications may access data stored in the multiple storage spaces during operation.

In some examples, a host system and/or application may send an excessive quantity of read and/or write requests that monopolizes the bandwidth (e.g., communication bandwidth and/or processing bandwidth) of the storage device such that other applications seeking to access the storage device (e.g., another storage spaces of the storage device) may do so with reduced performance or, in some cases, may be unable to access the storage device entirely. Thus, mechanisms (e.g., methods, systems, apparatuses, techniques, configurations, components) that ensure each host system having access to and/or each application at (e.g., installed at or running on) the host system(s) can access data stored in the memory system with a throughput that exceeds a throughput threshold may be desired.

To ensure each host system and/or application at the host system(s) can access data stored in a memory device system a minimum throughput, a set of relative priorities may be assigned to the memory spaces in a storage device, where the assigned priorities of the memory spaces may be used to implement a pattern for accessing the memory spaces that is weighted in accordance with the priorities while also ensuring each of the memory spaces can be accessed in accordance with a minimum throughput threshold.

In addition to applicability in memory systems as described herein, techniques for providing access to memory spaces in a distributed manner that is weighted based on priorities of the memory spaces while ensuring minimum access throughputs to the memory spaces may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by favoring access to (relatively) higher priority memory spaces and preventing (relatively) lower priority applications from monopolizing a memory system while ensuring fair access throughput to all of the memory spaces, which may improve a user experience across systems and applications while still prioritizing the operation of the most important systems and applications, among other benefits.

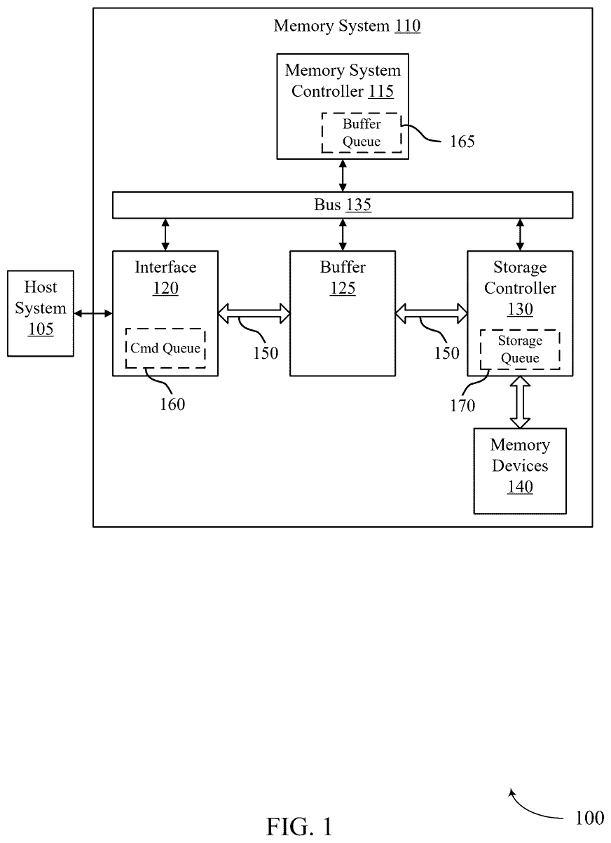

FIG. 1 shows an example of a system 100 that supports weighted distributed-access across memory spaces in accordance with examples as disclosed herein. The system 100 may include a memory system 110 configured to store data received from the host system 105 and to send data to the host system 105, if requested by the host system 105 using access commands (e.g., read commands or write commands).

The memory system 110 may include one or more memory devices 140 to store data transferred between the memory system 110 and the host system 105 (e.g., in response to receiving access commands from the host system 105). For example, the memory devices 140 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 110 may include a storage controller 130 for controlling the passing of data directly to and from the memory devices 140 (e.g., for storing data, for retrieving data, for determining memory locations in which to store data and from which to retrieve data). The storage controller 130 may communicate with memory devices 140 directly or via a bus (not shown), which may include using a protocol specific to each type of memory device 140. In some cases, a single storage controller 130 may be used to control multiple memory devices 140 of the same or different types. In some cases, the memory system 110 may include multiple storage controllers 130 (e.g., a different storage controller 130 for each type of memory device 140).

The memory system 110 may include an interface 120 for communication with the host system 105, and a buffer 125 for temporary storage of data being transferred between the host system 105 and the memory devices 140. The interface 120, buffer 125, and storage controller 130 may support translating data between the host system 105 and the memory devices 140 (e.g., as shown by a data path 150), and may be collectively referred to as data path components.

Using the buffer 125 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 125 may include relatively fast memory (e.g., some types of volatile memory, such as SRAM or DRAM), or hardware accelerators, or both to allow fast storage and retrieval of data to and from the buffer 125. The buffer 125 may include data path switching components for bi-directional data transfer between the buffer 125 and other components.

A temporary storage of data within a buffer 125 may refer to the storage of data in the buffer 125 during the execution of access commands. For example, after completion of an access command, the associated data may no longer be maintained in the buffer 125 (e.g., may be overwritten with data for additional access commands). In some examples, the buffer 125 may be a non-cache buffer. For example, data may not be read directly from the buffer 125 by the host system 105. In some examples, read commands may be added to a queue without an operation to match the address to addresses already in the buffer 125 (e.g., without a cache address match or lookup operation).

The memory system 110 also may include a memory system controller 115 for executing the commands received from the host system 105, which may include controlling the data path components for the moving of the data. A bus 135 may be used to communicate between the system components.

In some cases, one or more queues (e.g., a command queue 160, a buffer queue 165, a storage queue 170) may be used to control the processing of access commands and the movement of corresponding data. This may be beneficial, for example, if more than one access command from the host system 105 is processed concurrently by the memory system 110. The command queue 160, buffer queue 165, and storage queue 170 are depicted at the interface 120, memory system controller 115, and storage controller 130, respectively, as examples of a possible implementation. However, queues, if implemented, may be positioned anywhere within the memory system 110.

Data transferred between the host system 105 and the memory devices 140 may be conveyed along a different path in the memory system 110 than non-data information (e.g., commands, status information). For example, the system components in the memory system 110 may communicate with each other using a bus 135, while the data may use the data path 150 through the data path components instead of the bus 135. The memory system controller 115 may control how and if data is transferred between the host system 105 and the memory devices 140 by communicating with the data path components over the bus 135 (e.g., using a protocol specific to the memory system 110).

If a host system 105 transmits access commands to the memory system 110, the commands may be received by the interface 120 (e.g., according to a protocol, such as a UFS protocol or an eMMC protocol). Thus, the interface 120 may be considered a front end of the memory system 110. After receipt of each access command, the interface 120 may communicate the command to the memory system controller 115 (e.g., via the bus 135). In some cases, each command may be added to a command queue 160 by the interface 120 to communicate the command to the memory system controller 115.

The memory system controller 115 may determine that an access command has been received based on the communication from the interface 120. In some cases, the memory system controller 115 may determine the access command has been received by retrieving the command from the command queue 160. The command may be removed from the command queue 160 after it has been retrieved (e.g., by the memory system controller 115). In some cases, the memory system controller 115 may cause the interface 120 (e.g., via the bus 135) to remove the command from the command queue 160.

After a determination that an access command has been received, the memory system controller 115 may execute the access command. For a read command, this may include obtaining data from one or more memory devices 140 and transmitting the data to the host system 105. For a write command, this may include receiving data from the host system 105 and moving the data to one or more memory devices 140. In either case, the memory system controller 115 may use the buffer 125 for, among other things, temporary storage of the data being received from or sent to the host system 105. The buffer 125 may be considered a middle end of the memory system 110. In some cases, buffer address management (e.g., pointers to address locations in the buffer 125) may be performed by hardware (e.g., dedicated circuits) in the interface 120, buffer 125, or storage controller 130.

To process a write command received from the host system 105, the memory system controller 115 may determine if the buffer 125 has sufficient available space to store the data associated with the command. For example, the memory system controller 115 may determine (e.g., via firmware, via controller firmware), an amount of space within the buffer 125 that may be available to store data associated with the write command.

In some cases, a buffer queue 165 may be used to control a flow of commands associated with data stored in the buffer 125, including write commands. The buffer queue 165 may include the access commands associated with data currently stored in the buffer 125. In some cases, the commands in the command queue 160 may be moved to the buffer queue 165 by the memory system controller 115 and may remain in the buffer queue 165 while the associated data is stored in the buffer 125. In some cases, each command in the buffer queue 165 may be associated with an address at the buffer 125. For example, pointers may be maintained that indicate where in the buffer 125 the data associated with each command is stored. Using the buffer queue 165, multiple access commands may be received sequentially from the host system 105 and at least portions of the access commands may be processed concurrently.

If the buffer 125 has sufficient space to store the write data, the memory system controller 115 may cause the interface 120 to transmit an indication of availability to the host system 105 (e.g., a “ready to transfer” indication), which may be performed in accordance with a protocol (e.g., a UFS protocol, an eMMC protocol). As the interface 120 receives the data associated with the write command from the host system 105, the interface 120 may transfer the data to the buffer 125 for temporary storage using the data path 150. In some cases, the interface 120 may obtain (e.g., from the buffer 125, from the buffer queue 165) the location within the buffer 125 to store the data. The interface 120 may indicate to the memory system controller 115 (e.g., via the bus 135) if the data transfer to the buffer 125 has been completed.

After the write data has been stored in the buffer 125 by the interface 120, the data may be transferred out of the buffer 125 and stored in a memory device 140, which may involve operations of the storage controller 130. For example, the memory system controller 115 may cause the storage controller 130 to retrieve the data from the buffer 125 using the data path 150 and transfer the data to a memory device 140. The storage controller 130 may be considered a back end of the memory system 110. The storage controller 130 may indicate to the memory system controller 115 (e.g., via the bus 135) that the data transfer to one or more memory devices 140 has been completed.

In some cases, a storage queue 170 may support a transfer of write data. For example, the memory system controller 115 may push (e.g., via the bus 135) write commands from the buffer queue 165 to the storage queue 170 for processing. The storage queue 170 may include entries for each access command. In some examples, the storage queue 170 may additionally include a buffer pointer (e.g., an address) that may indicate where in the buffer 125 the data associated with the command is stored and a storage pointer (e.g., an address) that may indicate the location in the memory devices 140 associated with the data. In some cases, the storage controller 130 may obtain (e.g., from the buffer 125, from the buffer queue 165, from the storage queue 170) the location within the buffer 125 from which to obtain the data. The storage controller 130 may manage the locations within the memory devices 140 to store the data (e.g., performing wear-leveling, performing garbage collection). The entries may be added to the storage queue 170 (e.g., by the memory system controller 115). The entries may be removed from the storage queue 170 (e.g., by the storage controller 130, by the memory system controller 115) after completion of the transfer of the data.

To process a read command received from the host system 105, the memory system controller 115 may determine if the buffer 125 has sufficient available space to store the data associated with the command. For example, the memory system controller 115 may determine (e.g., via firmware, via controller firmware), an amount of space within the buffer 125 that may be available to store data associated with the read command.

In some cases, the buffer queue 165 may support buffer storage of data associated with read commands in a similar manner as discussed with respect to write commands. For example, if the buffer 125 has sufficient space to store the read data, the memory system controller 115 may cause the storage controller 130 to retrieve the data associated with the read command from a memory device 140 and store the data in the buffer 125 for temporary storage using the data path 150. The storage controller 130 may indicate to the memory system controller 115 (e.g., via the bus 135) when the data transfer to the buffer 125 has been completed.

In some cases, the storage queue 170 may be used to aid with the transfer of read data. For example, the memory system controller 115 may push the read command to the storage queue 170 for processing. In some cases, the storage controller 130 may obtain (e.g., from the buffer 125, from the storage queue 170) the location within one or more memory devices 140 from which to retrieve the data. In some cases, the storage controller 130 may obtain (e.g., from the buffer queue 165) the location within the buffer 125 to store the data. In some cases, the storage controller 130 may obtain (e.g., from the storage queue 170) the location within the buffer 125 to store the data. In some cases, the memory system controller 115 may move the command processed by the storage queue 170 back to the command queue 160.

After the data has been stored in the buffer 125 by the storage controller 130, the data may be transferred from the buffer 125 and sent to the host system 105. For example, the memory system controller 115 may cause the interface 120 to retrieve the data from the buffer 125 using the data path 150 and transmit the data to the host system 105 (e.g., according to a protocol, such as a UFS protocol or an eMMC protocol). For example, the interface 120 may process the command from the command queue 160 and may indicate to the memory system controller 115 (e.g., via the bus 135) that the data transmission to the host system 105 has been completed.

The memory system controller 115 may execute received commands according to an order (e.g., a first-in-first-out order, according to the order of the command queue 160). For each command, the memory system controller 115 may cause data corresponding to the command to be moved into and out of the buffer 125, as discussed herein. As the data is moved into and stored within the buffer 125, the command may remain in the buffer queue 165. A command may be removed from the buffer queue 165 (e.g., by the memory system controller 115) if the processing of the command has been completed (e.g., if data corresponding to the access command has been transferred out of the buffer 125). If a command is removed from the buffer queue 165, the address previously storing the data associated with that command may be available to store data associated with a new command.

In some examples, the memory system controller 115 may be configured for operations associated with one or more memory devices 140. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 140. For example, the host system 105 may issue commands indicating one or more LBAs and the memory system controller 115 may identify one or more physical block addresses indicated by the LBAs. In some cases, one or more contiguous LBAs may correspond to noncontiguous physical block addresses. In some cases, the storage controller 130 may be configured to perform one or more of the described operations in conjunction with or instead of the memory system controller 115. In some cases, the memory system controller 115 may perform the functions of the storage controller 130 and the storage controller 130 may be omitted.

The system 100 may include any quantity of non-transitory computer readable media that support weighted distributed-access across memory spaces. For example, the host system 105 or the memory system 110 may include or otherwise may access one or more non-transitory computer readable media storing instructions (e.g., firmware) for performing the functions ascribed herein to the host system 105 or memory system 110. For example, such instructions, if executed by the host system 105 (e.g., by a host system controller) or by the memory system (e.g., by a memory system controller), may cause the host system 105 or memory system 110 to perform associated functions as described herein.

The memory (e.g., having a capacity of 1 TB) supported by a memory system may be composed of memory regions (which may also be referred to as volumes). In some examples, the memory regions may be further partitioned into memory sub-regions (which may also be referred to as partitions). In some cases, both memory regions and memory sub-regions may be referred to generally as memory spaces.

In some examples, memory regions may be implemented as logical units (LUs) identifiable using logical unit numbers (LUNs). In some examples, a logical unit may be referenced by, or as, its LUN. In some examples, a logical unit may be a logical disk. The logical units may have different sizes and may be used to store different types of data. For example, a first logical unit (having a first LUN) may be designated as a code execution unit and used to store executable code for an operating system and/or applications installed for a host system, and a second logical unit (having a second LUN) may be designated as a mass storage unit and used to store user-level data.

In some examples, one or more of the LUNs at a memory system may be indicated as a high priority LUN. A logical unit having a high priority LUN may be used to store certain types of data (e.g., system-level and application-level executable code). In some examples, a device descriptor parameter may indicate the one or more LUNs at the memory system as high priority LUNs. In some examples, the memory system is configured to designate a single LUN as the high priority LUN.

In some examples, commands received at the memory system that are addressed to the high priority LUN may be processed before any other commands currently waiting for execution at the memory system and/or any commands received after the commands for the high priority LUN. In some examples, commands received at the memory system may, themselves, also indicate priorities—e.g., a command that is received as a head of queue order (e.g., in accordance with a Small Computer System Interface (SCSI) protocol) command may have higher priorities than other commands that are received as regular mode (e.g., in accordance with the SCSI protocol) commands. In yet other examples, a command may indicate its priority by setting the Universal Flash Storage (UFS) protocol information unit (UPIU) command priority flag in a UPIU including the command. In some cases, commands for the high priority LUN may be executed before all other high priority commands (e.g., head of order queue commands, UPIU high priority flagged commands, etc.).

In some examples, a memory system may include a high priority command queue used to execute the commands that are associated with a high priority operation and one or more normal priority queues used to execute other commands. In such cases, commands that enter the high priority queue may be executed as soon as possible and execution of commands in the normal priority queues may be stalled until the commands in the high priority queue have all been executed.

One or more host systems (e.g., a navigation system, an autonomous driving system, an entertainment system, a diagnostic system, a wireless communication system, etc.) may have access to a memory system. Similarly, one or more applications installed at the one or more host system may have access to the memory system. Data may be stored for one or more host systems/applications in one or more memory spaces (e.g., one or more logical units, one or more partitions) of the memory system. In some examples, data for the individual host systems and/or applications may be stored in respective memory spaces. In other examples, data for the individual host systems and/or applications may be stored in one or more shared memory spaces. In some examples, certain data (e.g., executable code code) for the individual host systems and/or applications may be stored in one memory space while other data (e.g., user data) may be stored in another memory space. In such cases, the host systems/applications may access data stored in one or more of the memory spaces during operation.

In some examples, a host system and/or application may send an excessive quantity of read and/or write requests that monopolizes the storage bandwidth such that other applications seeking to access the storage device (e.g., another memory space of the storage device) may access the storage device with reduced performance or, in some cases, may be prevented from accessing the storage device entirely. Thus, mechanisms (e.g., methods, systems, apparatuses, techniques, configurations, components) that ensure each host system having access to and/or each application at (e.g., installed at or running on) the host system(s) can access data stored in the memory system with a throughput that exceeds a throughput threshold may be desired.

To ensure each host system and/or application at the host system(s) can access data stored in a memory device system a minimum throughput, a set of relative priorities may be assigned to the memory spaces in a storage device, where the assigned priorities of the memory spaces may be used to implement a pattern for accessing the memory spaces that is weighted in accordance with the priorities while also ensuring each of the memory spaces can be accessed in accordance with a minimum throughput threshold.

The memory system 110 (e.g., via the memory system controller 115) may be configured to receive a sequence of commands that includes commands for multiple memory spaces of the memory system 110. For example, the memory system 110 (e.g., via the memory system controller 115) may receive, within a time period, a sequence of commands that includes first commands for a first memory space (e.g., a first logical unit, a first partition of the first logical unit) of the memory system 110, second commands for a second memory space (e.g., a second logical unit, a second partition of the first logical unit) of the memory system 110, and third commands for a third memory space (e.g., a third logical unit, a third partition of the first logical unit) of the memory system 110. The first memory space may be associated with a first priority, the second memory space may be associated with a second priority, and the third memory space may be associated with a third priority. In some examples, the first priority is higher than the second priority and the second priority is higher than the third priority. The relative priorities of the memory spaces may indicate that commands for the higher priority memory spaces are to be prioritized (e.g., executed before, executed at higher throughputs than, or a combination thereof) over command for lower priority memory spaces. In some examples, the first commands, the second commands, and the third commands may be stored in the command queue 160 at a same time.

The memory system 110 (e.g., via the memory system controller 115) may be configured to execute the sequence of commands in accordance with an interleaving pattern that is based on the relative priorities associated with the sequency of commands. In some examples, the interleaving pattern is a weighted interleaving pattern that is implemented to prioritize commands for higher priority memory spaces while also ensuring at least minimum access throughput to the lower priority memory spaces. For example, for the first, second, and third commands in the command queue 160, the interleaving pattern may interleave the first, second, and third commands so that the higher priority commands are executed at a higher access throughput (e.g., at greater frequencies, in larger batches, etc.) than the lower priority commands but such that the lower priority commands are executed with a minimum access throughput. In some examples, the memory system 110 (e.g., via the memory system controller 115) loads the commands in the command queue 160 into the storage queue 170 in accordance with the interleaving pattern, and then executes the commands in the storage queue 170 in an ordered fashion (e.g., starting at a beginning of the storage queue 170).

By executing the commands for different memory spaces in accordance with a pattern (e.g., interleaved round robin pattern) that is weighted in accordance with priorities assigned to the memory spaces while ensuring minimum access throughput for the memory spaces, the commands may be executed in a way that favors the higher priority commands directed to the higher priority memory spaces while ensuring that the lower priority commands directed to the lower priority memory spaces are not entirely (for an excessive duration of time) prevented from being executed (e.g., ensuring a minimum throughput for the lower priority commands directed to the lower priority memory spaces).

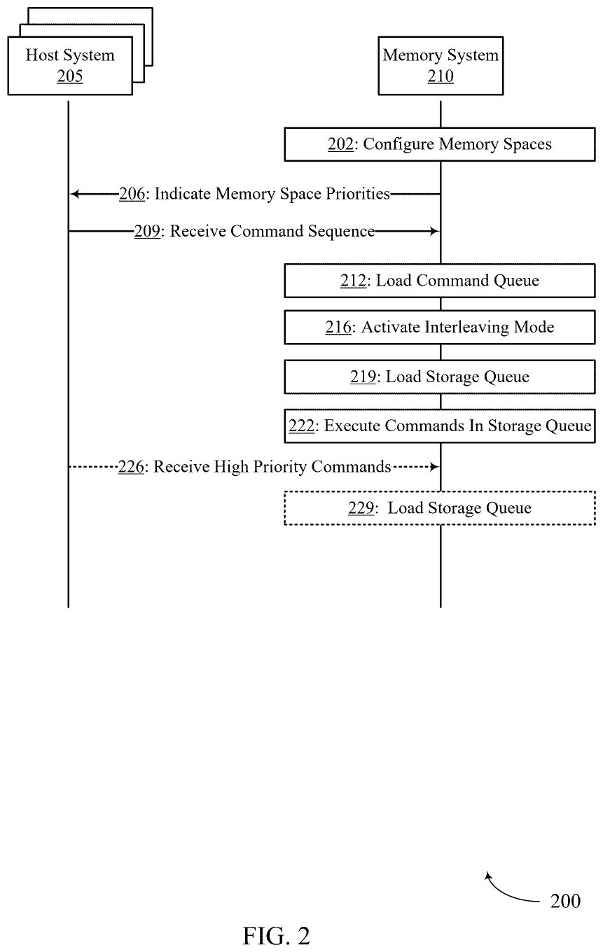

FIG. 2 shows an example of a set of operations for weighted distributed-access across memory spaces in accordance with examples as disclosed herein.

The process flow 200 may be performed by one or more host systems (e.g., including the host system 205) and a memory system 210, which may be respective examples of a host system (e.g., host system 105 of FIG. 1) and a memory system (e.g., memory system 110 of FIG. 1) described herein. In some examples, the process flow 200 shows an example set of operations performed to support weighted distributed-access across memory spaces. For example, the process flow 200 may include operations for executing a sequence of commands (that includes commands for different memory spaces in the memory system) in accordance with a weighted interleaving pattern that favors higher priority commands while ensuring lower priority commands a minimum execution throughput.

At 202, multiple memory spaces may be configured at the memory system 210—e.g., during an (e.g., an initial or pre-deployment) configuration procedure. As part of configuring the memory spaces, the memory of the memory system 210 may be partitioned into the multiple memory spaces, where each memory space may be configured to have a particular size (e.g., x gigabytes). In some examples, a memory space is a logical unit. In other examples, a memory space is a partition in a logical unit.

During the configuration procedure, one of the memory spaces may be designated as a high priority memory space (e.g., one or more memory spaces having LUNs designated as a high priority LUN). Commands received for the high priority memory space may be loaded into a high priority storage queue and executed before commands that are stored in a low priority storage queue. In some examples, the high priority LUN may be designated in response to a command received during the configuration procedure. An identity of the high priority LUN may be stored at the memory system 210 and may be communicated to a host system in a Device Descriptor UPIU. Particularly, the identity of the high priority LUN may be indicated in the bHighPriorityLUN field at offset 0Bh of the Device Descriptor UPIU—e.g., by indicating a value corresponding to the LUN of the logical unit designated as the high priority LUN. In some examples, the bHighPriorityLUN parameter defines the high priority logical unit, where valid values of the bHighPriorityLUN parameter range from zero (0) to the number of logical units specified by bMaxNumberLU parameter. In some examples, to indicate that all of the memory spaces have the same priority (e.g., there are no high priority LUNs), the bHighPriorityLUN parameter may be set to hex: 7F.

As noted above, during the configuration procedure, parameters for each memory space may be designated. The parameters may include the number of allocation units assigned to the logical unit, the logical block size for the memory space, the type of memory in the memory space, and the like. The parameters may additionally include a memory space-level priority parameter (which may be referred to as a priority, or the bLUNPriorityScore). For example, during the configuration procedure, the configured memory spaces may be assigned different priorities—e.g., in response to one or more configuration commands. For example, a first memory space may be assigned a first priority, a second memory space may be assigned a second priority, and a third memory space may be assigned a third priority. In some examples, the assigned priorities are selected from a set of available priority values (e.g., from 0 through 255, where 255 may be the highest priority). In some examples, the memory system may include a fourth logical unit but may not receive a configuration command for the fourth logical unit. In such cases, the memory system may assign a lowest priority (e.g., 0) to the fourth memory space based on not receiving a configuration command for the fourth logical unit.

The priorities assigned to the individual memory spaces may be independent of the high priority memory space designation. Thus, in some cases, a memory space that is designated as the high priority memory space may also be assigned a memory-space level priority. In some examples, the priority assigned to the memory-space level priority may be lower than the highest memory-space level priority. In such cases, the high priority memory space designation may override the memory-space level priority as described herein.

At 206, the priorities of the memory spaces may be indicated to the host system 205. In some examples, the priorities of the memory spaces may be indicated to the host system 205 in response to a request from the host system 205 for a Unit Descriptor UPIU (e.g., in a bLUNPriorityScore field of the Unit Descriptor UPIU, which may be located at offset 30h of the Unit Descriptor UPIU). In some examples, the host system 205 may be configured to store different data in the different memory spaces based on the different priorities. For example, the host system 205 may be configured to store higher priority data (e.g., operation-critical data, safety-critical data) in the memory spaces designated as higher priority relative to lower priority data (e.g., media) stored in memory spaces designated as lower priority.

At 209, a command sequence may be received from the host system 205. The command sequence may include multiple sets of commands for multiple memory spaces. In some examples, the command sequence includes first commands associated with the first memory space having the first priority, second commands associated with the second memory space having the second priority, and third commands associated with the third memory space having the third priority.

At 212, the command sequence received from the host system 205 may be loaded into a command queue (e.g., as similarly described herein and with reference to the command queue 160 of FIG. 1) at the memory system 210. In some examples, the command sequence is loaded into the command queue in the order that the commands of the command sequence are received at the memory system 210. In some examples, the commands of the command sequence stored in the command queue includes first commands associated with the first memory space having the first priority, second commands associated with the second memory space having the second priority, and third commands associated with the third memory space having the third priority.

At 216, an interleaving mode may be activated for executing the commands in the command queue. In some examples, the interleaving mode is activated based on an identification that the commands stored in the command queue are directed to multiple memory spaces. Additionally, or alternatively, the interleaving mode may be activated based on an identification that the quantity of commands in the command queue exceeds a threshold. In some examples, the interleaving mode may be transitioned to from a normal mode in which commands in the command queue are executed in accordance with the order the commands were loaded into the command queue (except that commands directed to a high priority memory space may be loaded into a high priority storage queue and executed in front of other commands in the command queue and/or normal priority storage queue).

At 219, the commands in the command queue may be transferred into a storage queue (e.g., as similarly described herein and with reference to the storage queue 170 of FIG. 1). The commands in the command queue may be loaded into the storage queue in accordance with an interleaving pattern (e.g., based on the interleaving mode being activated). In such cases, the order in which the commands are loaded into the storage queue may be different than the order in which the commands were loaded into the command queue. In some examples, the interleaving pattern is an interleaved round robin algorithm that is weighted in accordance with the respective priorities of the commands in the command queue while being configured to maintain a lower access throughput limit for memory spaces of the memory system. Thus, in some examples, the commands associated with the higher priority memory spaces may be loaded into the storage queue at a higher frequency, in larger batches, etc. than the commands associated with the lower priority memory spaces, while still ensuring that the lower priority commands are serviced in a timely fashion.

At 222, the commands loaded into the storage queue may be executed—e.g., in accordance with the interleaving pattern. In some examples, the commands in the storage queue may be executed in the order that the commands were loaded into the storage queue.

At 226, commands associated with the memory space designated as the high priority memory space may be received at the memory system 210. In some examples, the commands associated with the high priority memory space may be automatically (if not already) assigned a highest priority of the set of priorities.

At 229, the commands associated with the high priority memory space may be loaded into the storage queue in accordance with the interleaving pattern—e.g., which may favor the commands associated with the high priority memory space more than commands for other memory spaces. In some examples, the commands associated with the high priority memory space may be loaded in a high priority storage queue separate from the interleaving pattern. In some examples, commands in the high priority storage queue may be executed before the commands in the normal priority storage queue—e.g., execution of the commands in the normal priority storage queue may be paused until all the commands in the high priority storage queue are executed.

Aspects of the process flow 200 may be implemented by respective controllers at the respective devices. Additionally, or alternatively, aspects of the process flow 200 may be implemented as instructions stored in memory (e.g., firmware stored in a memory coupled with a controller) at the respective devices. For example, the instructions, when executed by a controller at one of the respective devices, may cause the controller to perform the operations of the process flow 200 performed by that device. Similarly, the instructions, when executed by a controller at the other of the respective devices, may cause the controller to perform the operations of the process flow 200 performed by that device.

One or more of the operations described in the process flow 200 may be performed earlier or later, omitted, replaced, supplemented, or combined with another operation. Also, additional operations described herein may replace, supplement or be combined with one or more of the operations described in the process flow 200.

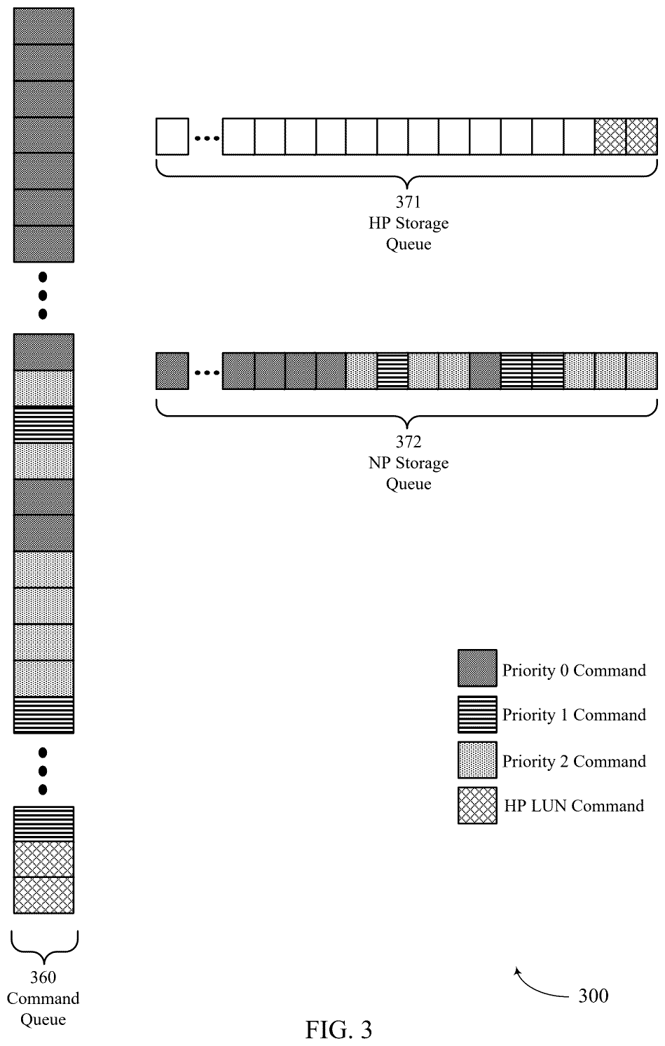

FIG. 3 shows example queue operations for weighted distributed-access across memory spaces in accordance with examples as disclosed herein.

The queue operation 300 depicts a command flow through the command queue 360, the high priority storage queue 371, and the normal priority storage queue 372 of a memory system. In some examples, the command queue 360 may be an example of a command queue described herein (e.g., the command queue 160 of FIG. 1). In some examples, the high priority storage queue 371 and the normal priority storage queue 372 may be parts of a storage queue as described herein (e.g., the storage queue 170 of FIG. 1). In some examples, the commands in the command queue 360 may be retrieved in a top-to-bottom order. In other examples, the command in the command queue 360 may be retrieved in any order desired by a memory system. In some examples, commands in the high priority storage queue 371 and the normal priority storage queue 372 may be executed in a right-to-left order.

In some examples, a host system may load the command queue 360 with commands for accessing data stored at a memory system. As described herein, the commands may include first commands (e.g., priority 0 commands) directed to a first memory space, second commands (e.g., priority 1 commands) directed to a second memory space, and third commands (e.g., priority 2 commands) directed to a third memory space. In some examples, the commands may also include fourth commands directed to the memory space in the memory system designated as the high priority memory space.

As described herein, in some examples, an application or host system may “flood” the command queue with the priority 0 commands for accessing data in the memory system. In some examples, the priority 0 commands are directed to lower priority data (e.g., data that is latency resilient, data that does not affect the operation of an application at the host system, data that does not affect the operation of an operating system of the host system, etc.) stored in a logical unit having a lower priority LUN. Concurrently, other applications or host systems may seek to access the memory system. For example, an application or host system may send priority 1 commands for accessing data in the memory system. The priority 1 commands may be directed to data that is higher priority than the data associated with the priority 0 commands (e.g., the data addressed by the priority 1 commands may be latency-sensitive). Additionally, an application or host system may send priority 2 commands for accessing data in the memory system. The priority 2 commands may be directed to data that is higher priority than the data associated with the priority 0 and 1 commands (e.g., the data addressed by the priority 2 commands may be operation-critical for an application or host system or may be associated with safety-critical data). Additionally, an application or host system may send high priority LUN commands. The high priority LUN commands may be directed to data that is higher priority than the priority 0, 1, and 2 commands (e.g., the data addressed by the high priority LUN commands may be safety-critical, such as data or code used to support autonomous driving).

As described herein, to support the proper execution of the commands in the command queue 360 without “starving” any of the applications of access to the memory system, the memory system may load the commands into the normal priority storage queue 372 in accordance with a weighted interleaved pattern. Except that, in some examples, the high priority LUN commands may be loaded into the high priority storage queue 371 separate from the other different-priority commands stored in the command queue 360. The weighted interleaved pattern may ensure that execution of the higher priority commands is favored over execution of the lower priority commands (e.g., by scheduling the higher priority commands in larger batches than the lower priority commands) while also ensuring that the lower priority commands are executed with a minimum throughput.

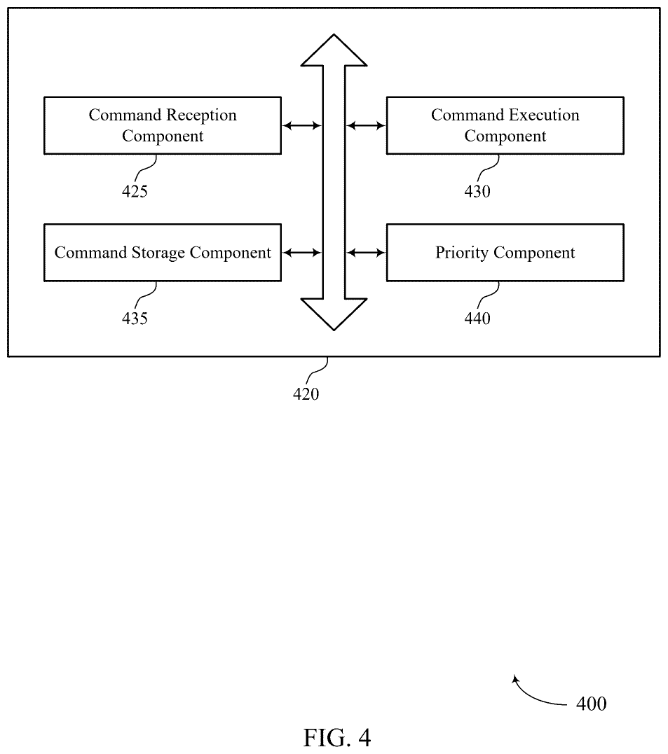

FIG. 4 shows a block diagram 400 of a memory system 420 that supports weighted distributed-access across memory spaces in accordance with examples as disclosed herein. The memory system 420 may be an example of aspects of a memory system as described with reference to FIGS. 1 through 3. The memory system 420, or various components thereof, may be an example of means for performing various aspects of weighted distributed-access across memory spaces as described herein. For example, the memory system 420 may include a command reception component 425, a command execution component 430, a command storage component 435, a priority component 440, or any combination thereof. Each of these components, or components of subcomponents thereof (e.g., one or more processors, one or more memories), may communicate, directly or indirectly, with one another (e.g., via one or more buses).

The command reception component 425 may be configured as or otherwise support a means for receiving a plurality of commands including first commands associated with a first memory space of the memory system that is assigned a first priority of a plurality of priorities, second commands associated with a second memory space of the memory system that is assigned a second priority of the plurality of priorities, and third commands associated with a third memory space of the memory system that is assigned a third priority of the plurality of priorities. The command execution component 430 may be configured as or otherwise support a means for executing, in accordance with receiving the plurality of commands, the plurality of commands using an interleaving pattern that is in accordance with the first priority, the second priority, and the third priority.

In some examples, the command storage component 435 may be configured as or otherwise support a means for storing, in accordance with receiving the plurality of commands, the plurality of commands into a queue, where an order of the plurality of commands in the queue is using the interleaving pattern, and where the plurality of commands are executed using the order of the plurality of commands in the queue.

In some examples, the command storage component 435 may be configured as or otherwise support a means for storing, prior to storing the plurality of commands into the queue, the plurality of commands into a second queue using an order the plurality of commands is received, the order the plurality of commands is received being different than the order of the plurality of commands in the queue.

In some examples, the command reception component 425 may be configured as or otherwise support a means for receiving, in accordance with receiving the plurality of commands, fourth commands of the plurality of commands associated with a fourth memory space that is assigned a fourth priority of the plurality of priorities and is designated, at the memory system, as a high priority memory space. In some examples, the priority component 440 may be configured as or otherwise support a means for using, in accordance with receiving the fourth commands, for the interleaving pattern, a highest priority of the plurality of priorities for the fourth commands instead of the fourth priority of the plurality of priorities.

In some examples, the command execution component 430 may be configured as or otherwise support a means for identifying, in accordance with receiving the plurality of commands, while in a first mode for executing commands, that the plurality of commands are associated with a plurality of memory spaces, where commands are executed in an order of reception in accordance with the first mode for executing commands being activated. In some examples, the command execution component 430 may be configured as or otherwise support a means for activating, in accordance with the plurality of commands being associated with the plurality of memory spaces, a second mode for executing commands, where the plurality of commands are executed using the interleaving pattern in accordance with the second mode for executing commands being activated.

In some examples, the command execution component 430 may be configured as or otherwise support a means for identifying, in accordance with receiving the plurality of commands, that a quantity of the plurality of commands in a queue is greater than a threshold, where the second mode for executing commands is activated in accordance with the quantity of the plurality of commands in the queue being greater than the threshold.

In some examples, the priority component 440 may be configured as or otherwise support a means for receiving, prior to receiving the plurality of commands, during an initial configuration procedure, one or more commands for configuring the first priority, the second priority, and the third priority of the first memory space, the second memory space, and the third memory space, respectively. In some examples, the priority component 440 may be configured as or otherwise support a means for assigning, in accordance with receiving the one or more commands, the first priority, the second priority, and the third priority to the first memory space, the second memory space, and the third memory space, respectively, using respective commands of the one or more commands.

In some examples, the priority component 440 may be configured as or otherwise support a means for assigning, prior to receiving the plurality of commands, a lowest priority of the plurality of priorities to a fourth memory space in accordance with failing to receive, during an initial configuration procedure, a command for configuring a fourth priority of the plurality of priorities for the fourth memory space.

In some examples, the priority component 440 may be configured as or otherwise support a means for indicating, prior to receiving the plurality of commands, to one or more host systems, respective priorities of a plurality of memory spaces of the memory system, the plurality of memory spaces including the first memory space, the second memory space, and the third memory space.

In some examples, the interleaving pattern is in accordance with an interleaved round robin algorithm that is weighted using the first priority, the second priority, and the third priority.

In some examples, the memory system includes a plurality of memory spaces that includes one or more logical units, one or more partitions, or both.

In some examples, the interleaving pattern is configured to maintain a lower access throughput limit for memory spaces of the memory system.

In some examples, the second priority is different than the first priority, and the third priority is different than the first priority and the second priority.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

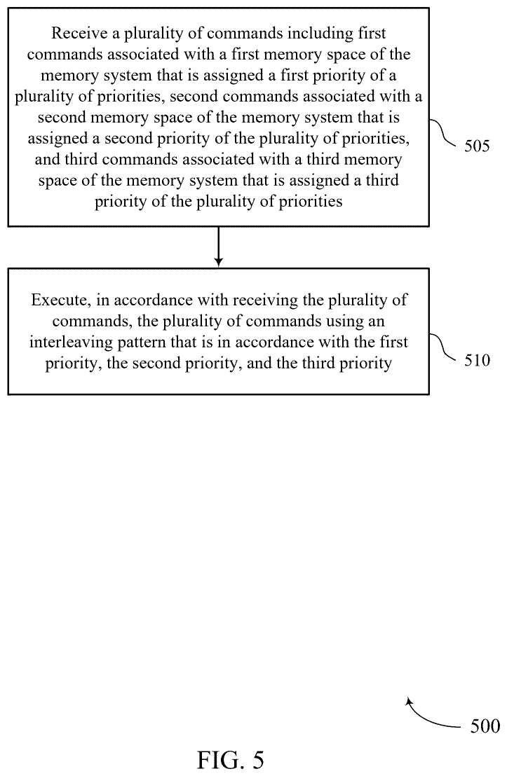

FIG. 5 shows a flowchart illustrating a method 500 that supports weighted distributed-access across memory spaces in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a plurality of commands including first commands associated with a first memory space of the memory system that is assigned a first priority of a plurality of priorities, second commands associated with a second memory space of the memory system that is assigned a second priority of the plurality of priorities, and third commands associated with a third memory space of the memory system that is assigned a third priority of the plurality of priorities. In some examples, aspects of the operations of 505 may be performed by a command reception component 425 as described with reference to FIG. 4.

At 510, the method may include executing, in accordance with receiving the plurality of commands, the plurality of commands using an interleaving pattern that is in accordance with the first priority, the second priority, and the third priority. In some examples, aspects of the operations of 510 may be performed by a command execution component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a plurality of commands including first commands associated with a first memory space of the memory system that is assigned a first priority of a plurality of priorities, second commands associated with a second memory space of the memory system that is assigned a second priority of the plurality of priorities, and third commands associated with a third memory space of the memory system that is assigned a third priority of the plurality of priorities and executing, in accordance with receiving the plurality of commands, the plurality of commands using an interleaving pattern that is in accordance with the first priority, the second priority, and the third priority.

Aspect 2: The method, apparatus, or non-transitory computer-readable medium of aspect 1, further including operations, features, circuitry, logic, means, or instructions, or any combination thereof for storing, in accordance with receiving the plurality of commands, the plurality of commands into a queue, where an order of the plurality of commands in the queue is using the interleaving pattern, and where the plurality of commands are executed using the order of the plurality of commands in the queue.

Aspect 3: The method, apparatus, or non-transitory computer-readable medium of aspect 2, further including operations, features, circuitry, logic, means, or instructions, or any combination thereof for storing, prior to storing the plurality of commands into the queue, the plurality of commands into a second queue using an order the plurality of commands is received, the order the plurality of commands is received being different than the order of the plurality of commands in the queue.

Aspect 4: The method, apparatus, or non-transitory computer-readable medium of any of aspects 1 through 3, further including operations, features, circuitry, logic, means, or instructions, or any combination thereof for receiving, in accordance with receiving the plurality of commands, fourth commands of the plurality of commands associated with a fourth memory space that is assigned a fourth priority of the plurality of priorities and is designated, at the memory system, as a high priority memory space and using, in accordance with receiving the fourth commands, for the interleaving pattern, a highest priority of the plurality of priorities for the fourth commands instead of the fourth priority of the plurality of priorities.

Aspect 5: The method, apparatus, or non-transitory computer-readable medium of any of aspects 1 through 4, further including operations, features, circuitry, logic, means, or instructions, or any combination thereof for identifying, in accordance with receiving the plurality of commands, while in a first mode for executing commands, that the plurality of commands are associated with a plurality of memory spaces, where commands are executed in an order of reception in accordance with the first mode for executing commands being activated and activating, in accordance with the plurality of commands being associated with the plurality of memory spaces, a second mode for executing commands, where the plurality of commands are executed using the interleaving pattern in accordance with the second mode for executing commands being activated.

Aspect 6: The method, apparatus, or non-transitory computer-readable medium of aspect 5, further including operations, features, circuitry, logic, means, or instructions, or any combination thereof for identifying, in accordance with receiving the plurality of commands, that a quantity of the plurality of commands in a queue is greater than a threshold, where the second mode for executing commands is activated in accordance with the quantity of the plurality of commands in the queue being greater than the threshold.

Aspect 7: The method, apparatus, or non-transitory computer-readable medium of any of aspects 1 through 6, further including operations, features, circuitry, logic, means, or instructions, or any combination thereof for receiving, prior to receiving the plurality of commands, during an initial configuration procedure, one or more commands for configuring the first priority, the second priority, and the third priority of the first memory space, the second memory space, and the third memory space, respectively and assigning, in accordance with receiving the one or more commands, the first priority, the second priority, and the third priority to the first memory space, the second memory space, and the third memory space, respectively, using respective commands of the one or more commands.

Aspect 8: The method, apparatus, or non-transitory computer-readable medium of any of aspects 1 through 7, further including operations, features, circuitry, logic, means, or instructions, or any combination thereof for assigning, prior to receiving the plurality of commands, a lowest priority of the plurality of priorities to a fourth memory space in accordance with failing to receive, during an initial configuration procedure, a command for configuring a fourth priority of the plurality of priorities for the fourth memory space.

Aspect 9: The method, apparatus, or non-transitory computer-readable medium of any of aspects 1 through 8, further including operations, features, circuitry, logic, means, or instructions, or any combination thereof for indicating, prior to receiving the plurality of commands, to one or more host systems, respective priorities of a plurality of memory spaces of the memory system, the plurality of memory spaces including the first memory space, the second memory space, and the third memory space.

Aspect 10: The method, apparatus, or non-transitory computer-readable medium of any of aspects 1 through 9, where the interleaving pattern is in accordance with an interleaved round robin algorithm that is weighted using the first priority, the second priority, and the third priority.

Aspect 11: The method, apparatus, or non-transitory computer-readable medium of any of aspects 1 through 10, where the memory system includes a plurality of memory spaces that includes one or more logical units, one or more partitions, or both.

Aspect 12: The method, apparatus, or non-transitory computer-readable medium of any of aspects 1 through 11, where the interleaving pattern is configured to maintain a lower access throughput limit for memory spaces of the memory system.

Aspect 13: The method, apparatus, or non-transitory computer-readable medium of any of aspects 1 through 12, where the second priority is different than the first priority, and the third priority is different than the first priority and the second priority.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and a second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a plurality of commands comprising first commands associated with a first memory space of the memory system that is assigned a first priority of a plurality of priorities, second commands associated with a second memory space of the memory system that is assigned a second priority of the plurality of priorities, and third commands associated with a third memory space of the memory system that is assigned a third priority of the plurality of priorities; and
execute, in accordance with receiving the plurality of commands, the plurality of commands using an interleaving pattern that is in accordance with the first priority, the second priority, and the third priority.

2. The memory system of claim 1, wherein the processing circuitry is further configured to cause the memory system to:
store, in accordance with receiving the plurality of commands, the plurality of commands into a queue, wherein an order of the plurality of commands in the queue is using the interleaving pattern, and wherein the plurality of commands are executed using the order of the plurality of commands in the queue.

3. The memory system of claim 2, wherein the processing circuitry is further configured to cause the memory system to:
store, prior to storing the plurality of commands into the queue, the plurality of commands into a second queue using an order the plurality of commands is received, the order the plurality of commands is received being different than the order of the plurality of commands in the queue.

4. The memory system of claim 1, wherein the processing circuitry is further configured to cause the memory system to:
receive, in accordance with receiving the plurality of commands, fourth commands of the plurality of commands associated with a fourth memory space that is assigned a fourth priority of the plurality of priorities and is designated, at the memory system, as a high priority memory space; and
use, in accordance with receiving the fourth commands, for the interleaving pattern, a highest priority of the plurality of priorities for the fourth commands instead of the fourth priority of the plurality of priorities.

5. The memory system of claim 1, wherein the processing circuitry is further configured to cause the memory system to:
identify, in accordance with receiving the plurality of commands, while in a first mode for executing commands, that the plurality of commands are associated with a plurality of memory spaces, wherein commands are executed in an order of reception in accordance with the first mode for executing commands being activated; and
activate, in accordance with the plurality of commands being associated with the plurality of memory spaces, a second mode for executing commands, wherein the plurality of commands are executed using the interleaving pattern in accordance with the second mode for executing commands being activated.

6. The memory system of claim 5, wherein the processing circuitry is further configured to cause the memory system to:
identify, in accordance with receiving the plurality of commands, that a quantity of the plurality of commands in a queue is greater than a threshold, wherein the second mode for executing commands is activated in accordance with the quantity of the plurality of commands in the queue being greater than the threshold.

7. The memory system of claim 1, wherein the processing circuitry is further configured to cause the memory system to:
receive, prior to receiving the plurality of commands, during an initial configuration procedure, one or more commands for configuring the first priority, the second priority, and the third priority of the first memory space, the second memory space, and the third memory space, respectively; and
assign, in accordance with receiving the one or more commands, the first priority, the second priority, and the third priority to the first memory space, the second memory space, and the third memory space, respectively, using respective commands of the one or more commands.

8. The memory system of claim 1, wherein the processing circuitry is further configured to cause the memory system to:
assign, prior to receiving the plurality of commands, a lowest priority of the plurality of priorities to a fourth memory space in accordance with failing to receive, during an initial configuration procedure, a command for configuring a fourth priority of the plurality of priorities for the fourth memory space.

9. The memory system of claim 1, wherein the processing circuitry is further configured to cause the memory system to:
indicate, prior to receiving the plurality of commands, to one or more host systems, respective priorities of a plurality of memory spaces of the memory system, the plurality of memory spaces comprising the first memory space, the second memory space, and the third memory space.

10. The memory system of claim 1, wherein the interleaving pattern is in accordance with an interleaved round robin algorithm that is weighted using the first priority, the second priority, and the third priority.

11. The memory system of claim 1, wherein the memory system comprises a plurality of memory spaces that comprises one or more logical units, one or more partitions, or both.

12. The memory system of claim 1, wherein the interleaving pattern is configured to maintain a lower access throughput limit for memory spaces of the memory system.

13. The memory system of claim 1, wherein the second priority is different than the first priority, and the third priority is different than the first priority and the second priority.

14. A non-transitory, computer-readable medium storing code that comprises instructions executable by processing circuitry of a memory system to cause the memory system to:
receive a plurality of commands comprising first commands associated with a first memory space of the memory system that is assigned a first priority of a plurality of priorities, second commands associated with a second memory space of the memory system that is assigned a second priority of the plurality of priorities, and third commands associated with a third memory space of the memory system that is assigned a third priority of the plurality of priorities; and
execute, in accordance with receiving the plurality of commands, the plurality of commands using an interleaving pattern that is in accordance with the first priority, the second priority, and the third priority.

15. The non-transitory, computer-readable medium of claim 14, wherein the instructions are further executable by the processing circuitry to cause the memory system to:
store, in accordance with receiving the plurality of commands, the plurality of commands into a queue, wherein an order of the plurality of commands in the queue is using the interleaving pattern, and wherein the plurality of commands are executed using the order of the plurality of commands in the queue.

16. The non-transitory, computer-readable medium of claim 14, wherein the instructions are further executable by the processing circuitry to cause the memory system to:
receive, in accordance with receiving the plurality of commands, fourth commands of the plurality of commands associated with a fourth memory space that is assigned a fourth priority of the plurality of priorities and is designated, at the memory system, as a high priority memory space; and
use, in accordance with receiving the fourth commands, for the interleaving pattern, a highest priority of the plurality of priorities for the fourth commands instead of the fourth priority of the plurality of priorities.

17. The non-transitory, computer-readable medium of claim 14, wherein the instructions are further executable by the processing circuitry to cause the memory system to:
identify, in accordance with receiving the plurality of commands, while in a first mode for executing commands, that the plurality of commands are associated with a plurality of memory spaces, wherein commands are executed in an order of reception in accordance with the first mode for executing commands being activated; and
activate, in accordance with the plurality of commands being associated with the plurality of memory spaces, a second mode for executing commands, wherein the plurality of commands are executed using the interleaving pattern in accordance with the second mode for executing commands being activated.

18. The non-transitory, computer-readable medium of claim 14, wherein the instructions are further executable by the processing circuitry to cause the memory system to:
receive, prior to receiving the plurality of commands, during an initial configuration procedure, one or more commands for configuring the first priority, the second priority, and the third priority of the first memory space, the second memory space, and the third memory space, respectively; and
assign, in accordance with receiving the one or more commands, the first priority, the second priority, and the third priority to the first memory space, the second memory space, and the third memory space, respectively, using respective commands of the one or more commands.

19. The non-transitory, computer-readable medium of claim 14, wherein the instructions are further executable by the processing circuitry to cause the memory system to:
assign, prior to receiving the plurality of commands, a lowest priority of the plurality of priorities to a fourth memory space in accordance with failing to receive, during an initial configuration procedure, a command for configuring a fourth priority of the plurality of priorities for the fourth memory space.

20. The non-transitory, computer-readable medium of claim 14, wherein the instructions are further executable by the processing circuitry to cause the memory system to:
indicate, prior to receiving the plurality of commands, to one or more host systems, respective priorities of a plurality of memory spaces of the memory system, the plurality of memory spaces comprising the first memory space, the second memory space, and the third memory space.

21. A method by a memory system, comprising:
receive a plurality of commands comprising first commands associated with a first memory space of the memory system that is assigned a first priority of a plurality of priorities, second commands associated with a second memory space of the memory system that is assigned a second priority of the plurality of priorities, and third commands associated with a third memory space of the memory system that is assigned a third priority of the plurality of priorities; and
execute, in accordance with receiving the plurality of commands, the plurality of commands using an interleaving pattern that is in accordance with the first priority, the second priority, and the third priority.

22. The method of claim 21, further comprising:
storing, in accordance with receiving the plurality of commands, the plurality of commands into a queue, wherein an order of the plurality of commands in the queue is using the interleaving pattern, and wherein the plurality of commands are executed using the order of the plurality of commands in the queue.

23. The method of claim 21, further comprising:
receiving, in accordance with receiving the plurality of commands, fourth commands of the plurality of commands associated with a fourth memory space that is assigned a fourth priority of the plurality of priorities and is designated, at the memory system, as a high priority memory space; and
using, in accordance with receiving the fourth commands, for the interleaving pattern, a highest priority of the plurality of priorities for the fourth commands instead of the fourth priority of the plurality of priorities.

24. The method of claim 21, further comprising:
identifying, in accordance with receiving the plurality of commands, while in a first mode for executing commands, that the plurality of commands are associated with a plurality of memory spaces, wherein commands are executed in an order of reception in accordance with the first mode for executing commands being activated; and
activating, in accordance with the plurality of commands being associated with the plurality of memory spaces, a second mode for executing commands, wherein the plurality of commands are executed using the interleaving pattern in accordance with the second mode for executing commands being activated.

25. The method of claim 21, further comprising:
receiving, prior to receiving the plurality of commands, during an initial configuration procedure, one or more commands for configuring the first priority, the second priority, and the third priority of the first memory space, the second memory space, and the third memory space, respectively; and
assigning, in accordance with receiving the one or more commands, the first priority, the second priority, and the third priority to the first memory space, the second memory space, and the third memory space, respectively, using respective commands of the one or more commands.
